(19) United States
(12) Patent Application Publication
(10) Pub. No.: US 2010/0001597 A1
(43) Pub. Date: Jan. 7, 2010

(54) Electric Motor

(76) Inventor: Michael Noll, Konigstein (DE)

Correspondence Address: King & Spalding LLP, 401 Congress Avenue, Suite 3200, Austin, TX, 78701, US

(21) Appl. No.: 11/722,235

(22) PCT Filed: Oct. 5, 2006
(86) PCT No.: PCT/EP06/67084

§ 371 Date: Jun. 20, 2007

(30) Foreign Application Priority Data
Nov. 2, 2005 (DE) 10 2005 052 364.1

(51) Int. Cl. H02K 5/20; H02K 9/00

(52) U.S. Cl. 310/58; 310/89

(57) ABSTRACT

The electric motor has a rotor (1), at least two magnet segments (2, 2′), a magnetic return path ring (3) and a housing (4) consisting of aluminum. The housing (4) has at least one helical projection (4′) on its outer side parallel to the longitudinal axis of the electric motor. An outer cover (5) in the form of a cup is arranged around the housing (4), the at least one helical projection (4′) resting against the inner side of said outer cover, wherein the outer cover (5) in the form of a cup has a coolant inlet (6) and a coolant outlet (7).

### CROSS-REFERENCE TO RELATED APPLICATIONS

This application is a U.S. national stage application of International Application No. PCT/EP2006/067084 filed Oct. 5, 2006, which designates the United States of America, and claims priority to German application number 10 2005 052 364.1 filed Nov. 2, 2005, the contents of which are hereby incorporated by reference in their entirety.

### TECHNICAL FIELD

The invention relates to an electric motor and to a use of the electric motor.

### BACKGROUND

Electric motors are known. An electric motor with a multi-pole rotor and a multi-pole stator is described in DE 102 26 976 A1. The electric motor is provided with stator poles encircled by stator windings pointing radially toward the rotor. A rigid insulating sleeve is arranged between the stator and the rotor which extends at least over the length of the rotor, and has projections arranged radially with respect to the rotor, each projection being arranged between two adjacent stator poles. When using electric motors of different design, it is generally disadvantageous that a motor heating occurs during operation, which has to be appropriately dissipated. As a rule, this takes place by means of the ambient air, although in many cases a disadvantageous buildup of heat cannot be avoided.

There exits a need for an electric motor with which it is possible to dissipate the accumulating motor heat away from the area of the motor relatively quickly.

### SUMMARY

According to an embodiment, an electric motor may have a rotor, at least two magnet segments, a magnetic return path ring and a housing made from aluminum wherein the housing has at least one helical projection on its outer side parallel to the longitudinal axis of the electric motor, a cup-shaped outer cover is arranged around the housing, the at least one helical projection rests against the inner side of said outer cover, and wherein the cup-shaped outer cover has a coolant inlet and a coolant outlet.

According to another embodiment, an arrangement may comprising a camshaft in a motor vehicle, and an electric motor having a rotor for actuating said camshaft, at least two magnet segments, a magnetic return path ring and a housing made from aluminum wherein the housing has at least one helical projection on its outer side parallel to the longitudinal axis of the electric motor, a cup-shaped outer cover is arranged around the housing, the at least one helical projection rests against the inner side of said outer cover, and wherein the cup-shaped outer cover has a coolant inlet and a coolant outlet.

### BRIEF DESCRIPTION OF THE DRAWINGS

The invention is explained in more detail and in an exemplary manner below with reference to the drawing (FIG. 1 to FIG. 3).

FIG. 1 shows the electric motor without commutator in longitudinal section.

FIG. 2 shows the detail A according to FIG. 1 in an enlarged view.

FIG. 3 shows the outside of the aluminum housing in side view.

### DETAILED DESCRIPTION

According to an embodiment, an electric motor may have a rotor, at least two magnet segments, a magnetic return path ring and a housing made from aluminum in which the housing has at least one helical projection on its outer side parallel to the longitudinal axis of the electric motor, and in which a cup-shaped outer cover is arranged around the housing, the at least one helical projection rests against the inner side of said outer cover, wherein the cup-shaped outer cover has a coolant inlet and a coolant outlet. Two, four or six or if necessary more magnet segments arranged in pairs can be used. The at least one helical projection can be constructed in different ways with regard to its cross-section. It must be ensured that this bears against the inner side of the cup-shaped outer cover and, in doing so, a sealing effect must be achieved. The cup-shaped outer cover has a coolant inlet and a coolant outlet, wherein aqueous solutions, for example, can be used for the coolant. Due to the arrangement of the at least one helical projection, a flow space for the coolant is formed between the aluminum housing and the cup-shaped outer cover in the area of the helical projection, it being ensured that the coolant washes virtually uniformly around the aluminum housing over virtually the whole length of the electric motor.

Surprisingly, it has been shown that the motor heat can be dissipated relatively quickly from the area of the electric motor when coolant washes around the aluminum housing in this way. This completely avoids the disadvantageous buildup of heat as a consequence of the heat dissipation to the ambient air, which only occurs slowly.

According to an embodiment, the ratio of the average distance b between two adjacent parts of the projection arranged in the longitudinal section to the average area B of the projection lies in the range from 2.8 to 3. If the projection is rectangular in section, for example, the average distance b corresponds exactly to the distance between two adjacent parts of the projection arranged in the longitudinal section. The average width B of the projection is then exactly equal to the width of the projection.

If the projection should be trapezoidal in cross-section, for example, then the average width B of the projection would be understood to be the average width in the trapezium in the longitudinal section. The average distance b would then be the distance between two adjacent parts of the projection arranged in the longitudinal section at the height of the average width B. If the ratio is set in the range from 2.8 to 3, then the flow relationships in the flow area formed are optimized, as a particularly large flow cross-section for the coolant is achieved in this way.

According to a further embodiment, the projection is chamfered on both sides, the slope angle a being in the range from 100° to 120°. This design embodiment of the projection guarantees that it can be used for many kinds of application, and simplifies the production of the electric motor so that serial manufacture can be realized in a relatively easy manner.

According to a further embodiment, it is provided that, a single helical projection is arranged, which extends from the coolant inlet to the coolant outlet. In doing so, it is advantageous that the aluminum housing can be produced in quantity with the help of a simple casting process and, at the same time, a uniform heat dissipation over the longitudinal side of the electric motor is assured.

Finally, the use of the electric motor for actuating camshafts in motor vehicles is proposed. Previously, the dissipation of motor heat has been problematic, particularly in the case of electric motors, which drive camshafts in motor vehicles. This problem can be solved particularly advantageously by the design of the flow space, wherein, in a particularly advantageous manner, water can be taken from the motor vehicle's cooling circuit as the coolant.

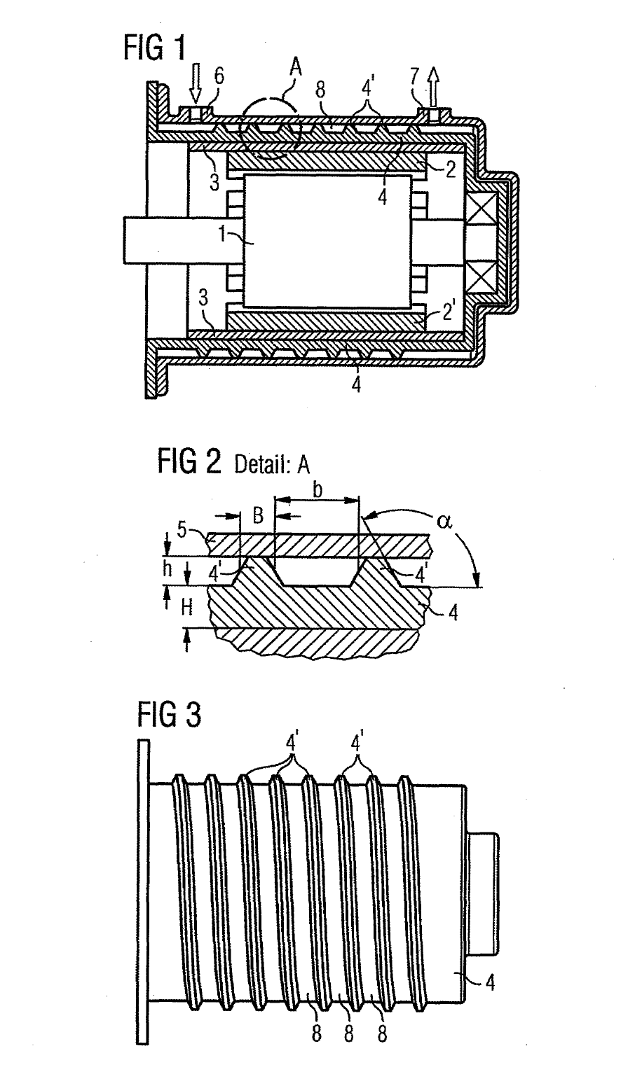

The electric motor without commutator, which has a rotor 1, two magnet segments 2, 2′, a magnetic return path ring 3 and a housing 4 made from aluminum is shown in longitudinal section in FIG. 1. The housing 4 has a helical projection 4′ on its outer side parallel to the longitudinal axis of the electric motor. A cup-shaped outer cover 5 is arranged around the housing 4, the helical projection 4′ resting against the inner side of said outer cover, wherein the cup-shaped outer cover 5 has a coolant inlet 6 and a coolant outlet 7 through which the coolant flows in the direction of the arrow. In this way the coolant is transported from the coolant inlet 6 over virtually the whole length of the electric motor to the coolant outlet 7, and flows uniformly around the aluminum housing 4, which leads to a rapid dissipation of the motor heat. In order to pass from the coolant inlet 6 to the coolant outlet 7, the coolant therefore flows through the flow space 8. The aluminum housing 4 is usually produced by means of a casting process. As shown in FIG. 1, a single helical projection 4′, which extends from the coolant inlet 6 to the coolant outlet 7, is arranged by this means.

The detail A according to FIG. 1 is shown in an enlarged view in FIG. 2. The ratio of the average distance b between two adjacent parts of the projection 4′ arranged in the longitudinal section to the average area B of the projection 4′ lies in the range from 2.8 to 3. The ratio of the average width B to the second height H preferably lies in the range from 0.5 to 0.8, which then leads to a very good dissipation of the motor heat. In the case shown, the helical projection 4′ is therefore designed to be trapezoidal in cross-section. The ratio of the first height h to the second height H, which corresponds to the actual wall thickness of the housing 4, usually lies between 1 and 1.2. This guarantees a large surface area of the housing, which accelerates the transfer of heat from the housing to the cooling medium. The projection 4′ is chamfered on both sides, the slope angle a being in the range from 100° to 120°.

The aluminum housing 4 is shown in side view in FIG. 3. On its outer side parallel to the longitudinal axis of the electric motor, the aluminum housing 4 has a helical projection 4′ by means of which the flow space 8 for the coolant is formed. If the electric motor should be used for actuating camshafts in motor vehicles, then cooling water from the motor vehicle's cooling circuit is particularly advantageous as a suitable coolant.

What is claimed is:

1. An electric motor having a rotor, at least two magnet segments, a magnetic return path ring and a housing made from aluminum wherein the housing has at least one helical projection on its outer side parallel to the longitudinal axis of the electric motor, a cup-shaped outer cover is arranged around the housing, the at least one helical projection rests against the inner side of said outer cover, and wherein the cup-shaped outer cover has a coolant inlet and a coolant outlet.

2. The electric motor as claimed in claim 1, wherein the ratio of the average distance b between two adjacent parts of the projection arranged in the longitudinal section to the average area B of the projection lies in the range from 2.8 to 3.

3. The electric motor as claimed in claim 1, in which wherein the projection is chamfered on both sides, the slope angle α being in the range from 100° to 120°.

4. The electric motor as claimed in claim 1, wherein a single helical projection is arranged, which extends from the coolant inlet to the coolant outlet.

5. An arrangement comprising a camshaft in a motor vehicle, and an electric motor having a rotor for actuating said camshaft, at least two magnet segments, a magnetic return path ring and a housing made from aluminum wherein the housing has at least one helical projection on its outer side parallel to the longitudinal axis of the electric motor, a cup-shaped outer cover is arranged around the housing, the at least one helical projection rests against the inner side of said outer cover, and wherein the cup-shaped outer cover has a coolant inlet and a coolant outlet.

6. The arrangement as claimed in claim 5, wherein the ratio of the average distance b between two adjacent parts of the projection arranged in the longitudinal section to the average area B of the projection lies in the range from 2.8 to 3.

7. The arrangement as claimed in claim 5, wherein the projection is chamfered on both sides, the slope angle α being in the range from 100° to 120°.

8. The arrangement as claimed in claim 5, wherein a single helical projection is arranged, which extends from the coolant inlet to the coolant outlet.
